(19) United States
(12) Patent Application Publication
(10) Pub. No.: US 2025/0182720 A1
(43) Pub. Date: Jun. 5, 2025

(54) INFORMATION PROCESSING APPARATUS AND INFORMATION PROCESSING METHOD

(71) Applicant: CANON KABUSHIKI KAISHA, Tokyo (JP)

(72) Inventors: Kenji SUGIYAMA, Kanagawa (JP); Atsushi NOGAMI, Kanagawa (JP)

(21) Appl. No.: 19/046,576

(22) Filed: Feb. 6, 2025

Related U.S. Application Data
(63) Continuation of application No. PCT/JP2023/019252, filed on May 24, 2023.

(30) Foreign Application Priority Data
Sep. 2, 2022 (JP) 2022-140203

(51) Int. Cl. G09G 5/377; G01N 21/88; G06T 7/00

(52) U.S. Cl. CPC G09G 5/377; G01N 21/8851; G06T 7/0012; G06T 2207/30096

(57) ABSTRACT

An information processing apparatus includes a first obtaining unit that obtains first detection information attached to a first image as metadata, a determination unit that determines a display method of the first detection information obtained by the first obtaining unit, and a display unit that superimposes and displays the first detection information on the first image based on the display method determined by the determination unit.

### CROSS-REFERENCE TO RELATED APPLICATIONS

This application is a Continuation of International Patent Application No. PCT/JP2023/019252, filed May 24, 2023, which claims the benefit of Japanese Patent Application No. 2022-140203, filed Sep. 2, 2022, both of which are hereby incorporated by reference herein in their entirety.

### BACKGROUND OF THE INVENTION

### Field of the Invention

The present invention relates to techniques for recording information attached to images to be displayable.

### Background Art

There is known a method of recording, as metadata, supplementary information such as the feature of a subject in a content data file such as an image (PTL1 and PTL2). In this method, since supplementary information is combined into one file, cost required to manage metadata is reduced and convenience when handling the information is improved. Similarly, by recording, in an inspection image file, as metadata, information of cracking or the like detected from an inspection image obtained by capturing a structure as an inspection target, it is possible to enjoy the above advantage.

### CITATION LIST

### Patent Literature

PTL 1 Japanese Patent Laid-Open No. 2021-033334
PTL 2 Japanese Patent Laid-Open No. 2022-501891

However, when a plurality of pieces of supplementary information are recorded as metadata in content data, it may be impossible to enjoy the above advantage. For example, when defect information stored in an inspection image file is superimposed and displayed on an inspection image, when all the pieces of defect information are superimposed, the visibility may degrade. In addition, even when the user can designate a display target, it may take time to perform a designation operation and convenience may degrade.

### SUMMARY OF THE INVENTION

The present invention has been made in view of the aforementioned problem, and realizes techniques capable of handling supplementary information recorded in content data while suppressing degradation in convenience.

In order to solve the aforementioned problems, the present invention provides an information processing apparatus comprising: a first obtaining unit that obtains first detection information attached to a first image as metadata; a determination unit that determines a display method of the first detection information obtained by the first obtaining unit; and a display unit that superimposes and displays the first detection information on the first image based on the display method determined by the determination unit.

In order to solve the aforementioned problems, the present invention provides an information processing apparatus comprising: an obtaining unit that obtains predetermined supplementary information recorded in a content data file; and a control unit that performs processing of the content data file and the predetermined supplementary information based on information included in the predetermined supplementary information and concerning a method for handling the predetermined supplementary information.

In order to solve the aforementioned problems, the present invention provides an information processing method comprising: obtaining detection information attached to an image as metadata; determining a display method of the obtained detection information; and superimposing and displaying the detection information on the image based on the determined display method.

In order to solve the aforementioned problems, the present invention provides an information processing method comprising: obtaining predetermined supplementary information recorded in a content data file; and performing processing of the content data file and the predetermined supplementary information based on information included in the predetermined supplementary information and concerning a method for handling the predetermined supplementary information.

Further features of the present invention will become apparent from the following description of exemplary embodiments (with reference to the attached drawings).

### BRIEF DESCRIPTION OF THE DRAWINGS

FIG. 1 is a block diagram illustrating a hardware configuration of an information processing apparatus according to a first embodiment.

FIG. 2 is a functional block diagram of the information processing apparatus according to the first embodiment.

FIG. 3 is a flowchart illustrating metadata record processing according to the first embodiment.

FIG. 4 is a flowchart illustrating metadata display processing according to the first embodiment.

FIG. 5 is a flowchart illustrating processing for instructing a metadata display method according to the first embodiment.

FIG. 6 is a view illustrating a data structure of defect information according to the first embodiment.

FIG. 7 is a diagram illustrating a reproduction screen of an inspection image and a defect information according to the first embodiment.

FIG. 8 is a functional block diagram of an information processing apparatus according to a second embodiment.

FIG. 9 is a flowchart illustrating metadata record processing and display processing according to the second embodiment.

FIG. 10 is a screen of a defect information list according to the second embodiment.

FIGS. 11A to 11E are diagrams illustrating a method for aligning inspection image and defect information according to the second embodiment.

FIG. 12 is a functional block diagram of an information processing apparatus according to a third embodiment.

FIG. 13 is a flowchart illustrating metadata record processing according to the third embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate.

Furthermore, in the attached drawings, the same reference numerals are given to the same or similar configurations, and redundant description thereof is omitted.

### First Embodiment

An embodiment of applying an information processing apparatus of the present invention to a computer apparatus used to inspect an infrastructure such as a concrete structure will be described below.

In the first embodiment, an example in which a computer apparatus operates as an information processing apparatus, records defect information (detected information) obtained by executing defect detection processing on an image (inspection image) of which an inspection target is captured as metadata in an inspection image file, and superimposes and displays the defect information on the inspection image when the inspection image file is reproduced.

The definitions of main terms used in the description of the present embodiment are as follows.

An “inspection target” is a concrete structure to be a target of infrastructure inspection, such as a motorway, a bridge, a tunnel, or a dam. The information processing apparatus performs defect detection processing for detecting the presence/absence and state of a defect, such as cracking, using an image in which an inspection target is captured by a user.

A ‘defect’ refers to a condition that has changed from a normal state due to factors such as an aged deterioration in a structure of the inspection target. In a case of a concrete structure, the defect is, for example, cracking, floating, or spalling of concrete. The defect also includes as other examples, efflorescence (crystalline deposit of salts), rebar exposure, rust, water leakage, water dripping, corrosion, damage (deficiency), cold joint, deposition, rock pocket, and the like.

“Defect information” indicates unique identification information given to each defect (type), coordinate information representing the position and shape of a defect, a detection date/time, a priority, data representing whether the information can be used as supervisory data or evaluation data for learning processing or inference processing, and the like.

“Metadata” is information concerning defect information, a display method of the defect information, and the like, which is recorded as supplementary information in an inspection image file.

### <Hardware Configuration>

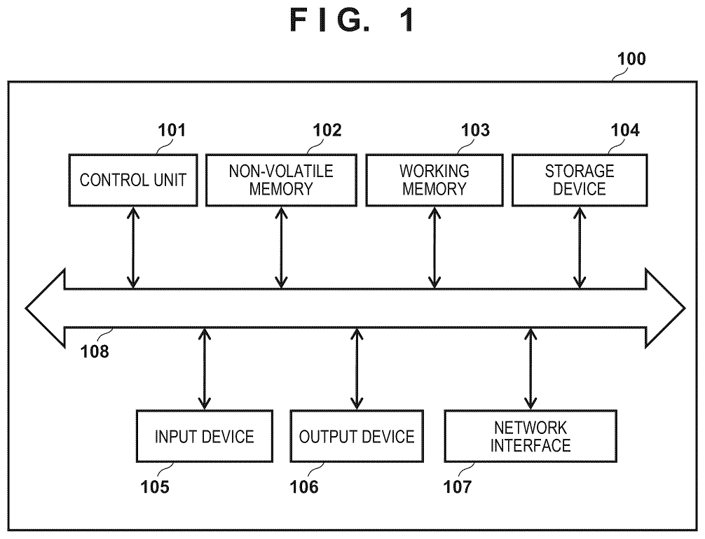

First, a hardware configuration of the information processing apparatus according to the first embodiment will be described with reference to FIG. 1.

FIG. 1 is a block diagram illustrating the hardware configuration of an information processing apparatus 100 according to the first embodiment.

In the present embodiment, a computer apparatus operates as the information processing apparatus 100. The processing of the information processing apparatus of the present embodiment may be realized by a single computer apparatus or may be realized by functions being distributed as necessary among a plurality of computer apparatuses. The plurality of computer apparatuses are connected to each other so as to be capable of communication.

The information processing apparatus 100 includes a control unit 101, a non-volatile memory 102, a working memory 103, a storage device 104, an input device 105, an output device 106, a network interface 107, and a system bus 108.

The control unit 101 includes a computational processor, such as a CPU or an MPU, for comprehensively controlling the entire information processing apparatus 100. The non-volatile memory 102 is a ROM for storing a program to be executed by the processor of the control unit 101 and parameters. Here, the program is a program for executing processing of first, second and third embodiments, which will be described later. The working memory 103 is a RAM for temporarily storing programs and data supplied from an external apparatus and the like. The working memory 103 holds data obtained by executing control processing which will be described later.

The storage device 104 is an internal device, such as a hard disk or a memory card incorporated in the information processing apparatus 100; an external device, such as a hard disk or a memory card connected to the information processing apparatus 100 so as to be capable of being attached thereto and detached therefrom; or a server device connected via a network. The storage device 104 includes a memory card, a hard disk, and the like configured by a semiconductor memory, a magnetic disk, and the like. The storage device 104 also includes a storage medium configured by a disk drive for reading data from and writing data to an optical disk, such as a DVD or a Blu-ray Disc.

The input device 105 is an operation member such as a mouse, a keyboard, or a touch panel for receiving a user operation, and outputs operation instructions to the control unit 101. The output device 106 is a display device, such as a display or a monitor configured by an LCD or organic EL, and displays a defect detection result generated by the information processing apparatus 100 or the server device. The network interface 107 is connected to a network, such as the Internet or a local area network (LAN), so as to be capable of communication. The system bus 108 includes an address bus, a data bus, and a control bus for connecting each of the components 101 to 107 of the information processing apparatus 100 so as to exchange data.

The non-volatile memory 102, stores an operating system (OS), which is basic software to be executed by the control unit 101, and applications for realizing applied functions in cooperation with the OS. Further, in the present embodiment, the non-volatile memory 102 stores an application with which the information processing apparatus 100 realizes control processing which will be described later.

The control processing of the information processing apparatus 100 according to the present embodiment is realized by reading the software provided by the application. Assume that the application includes software for utilizing basic functions of the OS installed in the information processing apparatus 100. The OS of the information processing apparatus 100 may include software for realizing the control processing in the present embodiment.

### <Functional Configuration>

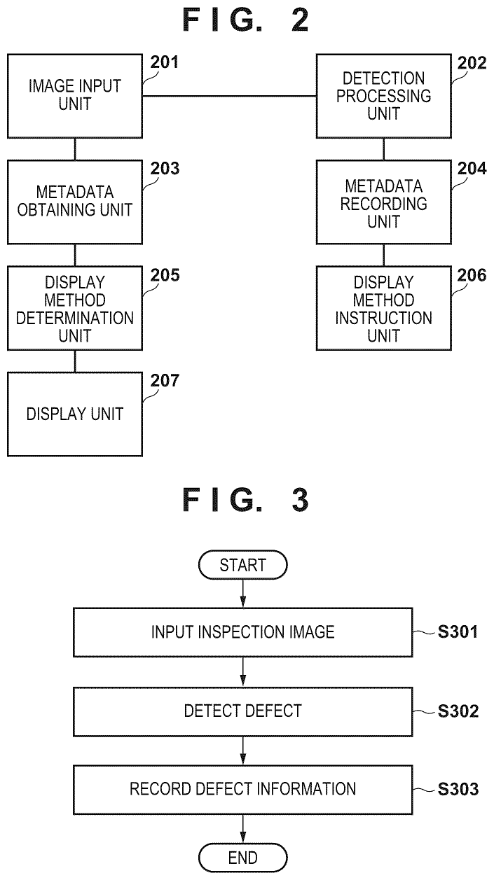

Next, functional blocks of the information processing apparatus 100 according to the first embodiment will be described with reference to FIG. 2.

FIG. 2 is a functional block diagram of the information processing apparatus 100 according to the first embodiment.

The information processing apparatus 100 includes an image input unit 201, a detection processing unit 202, a metadata obtaining unit 203, a metadata recording unit 204, a display method determination unit 205, a display method instruction unit 206, and a display unit 207.

Each function of the information processing apparatus 100 is configured by hardware and/or software. A configuration may be taken such that each functional unit is configured by one or more computer apparatuses or server apparatuses, and these constitute a system connected by a network. Further when each functional unit illustrated in FIG. 2 is configured by hardware instead of being realized by software, there need only be provided a circuit configuration corresponding to each functional unit in FIG. 2.

The image input unit 201 inputs an inspection image file for which defect detection processing is to be executed.

The detection processing unit 202 executes the defect detection processing for the inspection image input by the image input unit 201, and generates defect information as a detection result.

The metadata obtaining unit 203 obtains metadata from the inspection image file input by the image input unit 201.

The metadata recording unit 204 records, in the inspection image file, as metadata, the defect information generated by executing the defect detection processing for the inspection image.

The display method determination unit 205 determines a display method of the metadata obtained by the metadata obtaining unit 203.

The display method instruction unit 206 accepts a user operation associated with the display method of the metadata and the inspection image.

The display unit 207 superimposes and displays the defect information on the inspection image based on the display method determined by the display method determination unit 205.

### <Control Processing>

Control processing by the information processing apparatus 100 according to the first embodiment will be described next with reference to FIGS. 3 to 7.

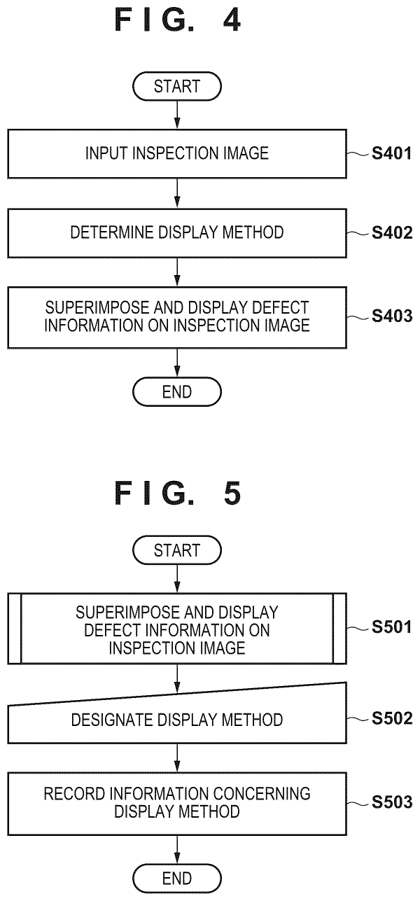

FIG. 3 exemplifies processing of recording defect information as metadata in an inspection image file. FIG. 4 exemplifies processing of reading out defect information from an image whose metadata is recorded and displaying it. FIG. 5 exemplifies processing of accepting a user operation of designating a metadata display method and recording information concerning the display method as metadata.

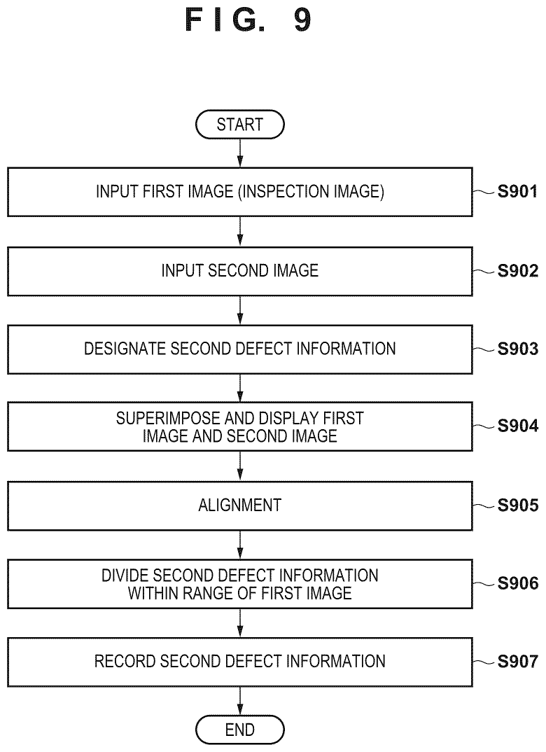

The processing shown in FIGS. 3 to 5 are implemented when the control unit 101 of the information processing apparatus 100 shown in FIG. 1 controls the respective components shown in FIG. 1 to operate as the respective functional units shown in FIG. 2 by deploying the programs stored in the non-volatile memory 102 to the working memory 103 and executing them. The processing shown in FIGS. 3 to 5 are started when the information processing apparatus 100 accepts an instruction to start the defect detection processing by the input device 105. The same applies to FIGS. 9 and 13 which will be described later.

The processing of recording the defect information as metadata in the inspection image file will be described first with reference to FIG. 3.

### <S301: Input of Image>

The image input unit 201 externally inputs, via the storage device 104 and the network I/F 107, an inspection image file designated by a user operation. An inspection image is, for example, an image obtained by capturing a wall surface of a structure as an inspection target, in which a defect such as cracking can visually be recognized. One or a plurality of images may be input, and when a plurality of images are input, the same processing is repeatedly performed for each of the images. In the first embodiment, one image is input.

As a method of designating the inspection image file, the user may directly designate the inspection image file via a Graphical User Interface (GUI), or another method may be used. For example, a folder in which an inspection image file is stored may be designated, and all files stored in the folder may be set as targets or a file that satisfies a condition designated by the user may be set as a target using a search tool.

### <S302: Defect Detection>

The detection processing unit 202 executes the defect detection processing for the inspection image input in step S301, and generates defect information as a detection result. The defect detection processing is processing of recognizing the feature of a defect by image analysis and extracting a position and a shape.

For example, the defect detection processing can be executed using a parameter and a learned model having undergone learning processing by machine learning of Artificial Intelligence (AI) or deep learning as a kind of machine learning. The learned model can be formed by, for example, a neural network model. For example, a learned model having undergone learning processing using a different parameter may be prepared for each type of cracking as a detection target defect and appropriately used for each type of cracking as a detection target, or a general learned model that can detect various types of cracking may be used. Alternatively, a learned model may appropriately be used based on texture information of the inspection image. As a method of obtaining texture information from the inspection image, for example, there is provided a determination method based on the spatial frequency information of the image obtained by FFT. Note that learning processing may be executed by a Graphics Processing Unit (GPU). The GPU is a processor capable of performing processing specialized for a computer graphics operation, and has an arithmetic processing capability for performing a matrix operation and the like necessary for learning processing in a short time. Note that the learning processing is not limited to the GPU and there need only be provided a circuit configuration that performs a matrix operation and the like necessary for a neural network.

The learned model and parameter used for the defect detection processing may be obtained from the server connected to the network via the network interface 107. The inspection image may be transmitted to the server to obtain, via the network interface 107, a result obtained by executing the defect detection processing using the learned model in the server.

Note that the defect detection processing is not limited to the method using the learned model, and may be implemented by performing, for example, image processing by wavelet transformation, image analysis processing, and image recognition processing for the inspection image. In this case as well, the detection result of a defect such as cracking is not limited to vector data and may be raster data.

The defect detection processing may be executed in parallel for a plurality of inspection images. In this case, the image input unit 201 inputs a plurality of images in step S301, and the detection processing unit 202 executes in parallel the defect detection processing for the images, thereby obtaining the detection results of the images. The obtained detection results are output as vector data of the image coordinate system associated with the respective images.

Note that the defect detection processing may be executed by visual observation by a human. In this case, for example, an inspector with experience and knowledge recognizes a defect in the inspection image, generates defect information using a design support tool such as CAD, and records it.

In the first embodiment, the defect detection processing is performed using a cloud service such as Software as a Service (SaaS).

### <S303: Recording of Defect Information>

The metadata recording unit 204 records, as metadata, the defect information detected in step S302 in an inspection image file. For example, the metadata recording unit 204 records the defect information as metadata in compliance with the Exchangeable image file format (Exif) standard.

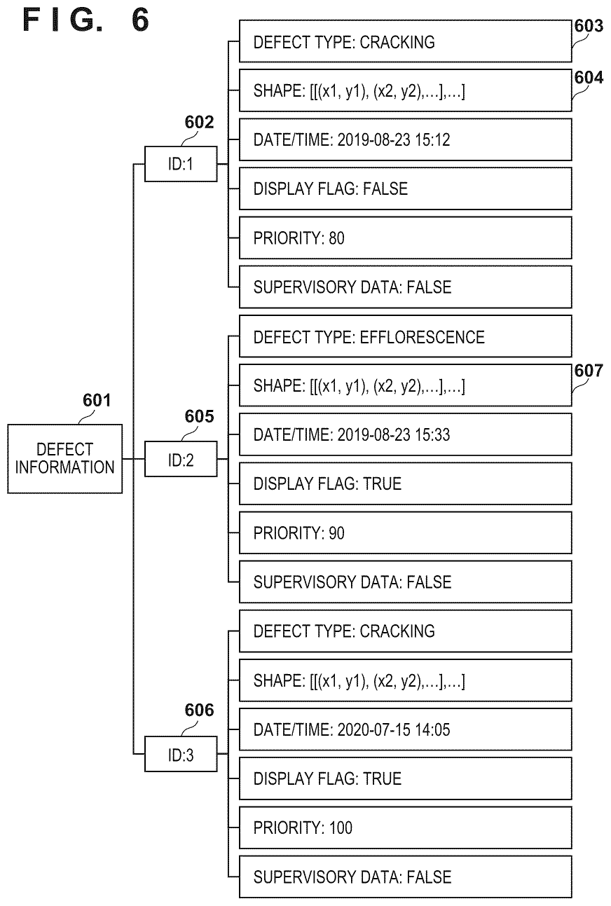

FIG. 6 exemplifies the data structure of the defect information recorded as the metadata in the inspection image file. The metadata has a hierarchical structure in which information 601 is an uppermost layer but the structure is not specifically limited. In the example shown in FIG. 6, the metadata has a three-layer structure of the information 601, information 602, and information 603.

The defect information can be stored in a plurality of layers. For example, in shape information 604 shown in FIG. 6, the shapes of a plurality of pieces of cracking are stored as vector data, and stored as one layer under the ID information 602. Similarly, the shapes of a plurality of defects are stored under ID information 605 and ID information 606. Thus, for example, the plurality of defects detected from the same inspection image can be stored in layers different for respective types. Furthermore, the past defect information and the current defect information, pieces of defect information detected using a plurality of learned models, pieces of defect information detected using a plurality of parameters by the same learned model, and the like can be distinguished and stored in different layers.

Each of the shape information 604 and shape information 607 is vector data representing the shape of the defect. For example, when the defect is cracking, it is represented as a polyline, and when the defect is efflorescence, it is represented as a polygon. Coordinate information forming the vector data is represented by coordinate information of the image coordinate system with the upper left point of the image as an origin. Note that information for defining a coordinate system may be recorded in the metadata, and the defect information may be recorded in the coordinate system other than the image coordinate system.

The defect information recorded as the metadata is not limited to the example shown in FIG. 6, but examples of information that is desirably managed together with an image are the following pieces of information including the information exemplified in FIG. 6.

### Unique Information (ID) for Identifying the Defect Information

A defect type
The position and shape of the defect
Information of the coordinate system used by the vector data representing the shape of the defect
The generation date/time of the defect information
A flag indicating whether to display the defect information
A flag indicating whether the defect information is usable as supervisory data of machine learning (to be described later in the third embodiment)
A flag indicating whether the defect information is usable as evaluation data of machine learning (to be described later in the third embodiment)
Information representing the importance of the defect or a priority when the defect information is displayed
A priority threshold for determining whether or not to display the defect information
Information for designating a level at which the shape of the defect information is drawn in a simplified or detailed manner
The shape of the defect information stored as the metadata need not always match the resolution of the image that stores the metadata, and the drawing level desired by the user changes depending on the purpose of use of the defect information and the defect type. Therefore, the defect information of an appropriate drawing level can be displayed by separately storing the drawing level of the shape of the defect information (to be described later in the second embodiment).
   A Degree of Transparency when the Defect Information is Drawn
When a plurality of pieces of defect information are displayed, it is possible to improve visibility by designating the degree of transparency for each piece of defect information.
   A Form when the Defect Information is Drawn, that is, the Thickness and Color of a Line and a Pattern when a Region is Filled
It is possible to improve visibility by setting the color of the line to a highlight color, hatching a region by oblique lines, filling a region with a specific color or a translucent color, or bordering a region.

### Information Such as the Name, Division, and Contact Address of an Inspector

Information such as the parameter and the ID of the learned model used for the defect detection processing
Information of the type, name, position coordinates, portion (a bridge pier, a slab, or the like) of the structure as the inspection target, and a direction in which the structure is captured
In a case of cracking, the difficulty of defect detection changes depending on the direction of the sun, and thus the information is useful when the defect detection result is evaluated.

### A Report Generation History

A history of reporting the defect information as the inspection result of the structure, a report generation date/time for each piece of defect information, and the like can be managed usefully together with the image file.

Processing of obtaining defect information from an inspection image file in which metadata is recorded, and displaying the defect information will be described next with reference to FIG. 4.

### <S401: Input of Image>

The image input unit 201 externally inputs, via the storage device 104 and the network I/F 107, an inspection image file designated by a user operation. Defect information is recorded as metadata in the inspection image file. In the first embodiment, an inspection image file generated in a cloud is input to the viewer of the information processing apparatus 100. Note that the detection processing unit 202 and the viewer (display unit 207) may be separate devices or the same device.

### <S402: Determination of Display Method>

The metadata obtaining unit 203 obtains the defect information recorded as the metadata in the inspection image file input in step S401. The display method determination unit 205 determines a method of appropriately superimposing and displaying a plurality of pieces of defect information without degrading visibility.

In the first embodiment, information whose defect type is latest is extracted from the plurality of pieces of defect information stored in the inspection image file and superimposed and displayed on the inspection image. In this case, in consideration of the characteristics of the defect types, a drawing order may further be determined among the pieces of extracted defect information. For example, by first drawing efflorescence drawn as a region and finally overwriting cracking drawn as a line segment, it is possible to prevent a situation in which the defect information of cracking cannot visually be recognized due to the defect information of efflorescence having a large area. The drawing order may be determined in advance in accordance with the characteristics of the defect types, or may dynamically be determined. For example, regions in each of which the pieces of defect information overlap each other are focused on, the drawing areas of the plurality of pieces of overlapping defect information are calculated in each region, and the pieces of defect information are drawn in descending order of the areas, thereby making it possible to prevent a situation in which the defect information having a small area cannot visually be recognized.

Other display methods using the related information of the defect information read out from the metadata will be exemplified below.
(1) Only the latest cracking is displayed. The method of displaying the latest detected defect information of cracking as a representative defect type is probably a display method responding to the interest of a person who manages the structure.
(2) The pieces of defect information are drawn in the order from the oldest date/time. A newer defect is drawn in an upper layer so the latest defect information is not hidden by old defect information.
(3) The latest defect information and the oldest defect information are displayed. It is easy to confirm aging of the defect.
(4) Only the defect information whose display flag is TRUE is displayed. Only the defect information explicitly recorded as a display target in the metadata is displayed.
(5) Only the defect information whose supervisory data flag is TRUE is displayed. When the inspection image is used as supervisory data of machine learning, the user is highly interested in display of the defect information explicitly recorded as supervisory data.
(6) Only the defect information whose display priority is highest or only the defect information whose display priority is equal to or higher than a predetermined threshold is displayed.
(7) Only the defect information having inspector information is displayed. The defect information for which inspector information is specified has higher reliability of a detection result than the defect information for which inspector information is unknown, and is considered to highly interest the user. The reliability may be determined in advance for each inspector, and the defect information may be limited to defect information having inspector information with high reliability. When there are a plurality of pieces of defect information by the same inspector, only the latest defect information may be displayed. Furthermore, the latest defect information of each inspector may be displayed.
(8) Only the defect information with the latest report generation date/time is displayed. When the inspection image file storing the defect information is used for an inspection result report, the user is highly interested in the latest defect information used for the report. Alternatively, by focusing on the interest during a process of generating the report, only the defect information for which there is no report generation history, that is, only the defect information that has not been reported may be displayed. Furthermore, among the pieces of defect information for which there is no report generation history, only the latest defect information may be extracted and displayed.

As described above, the display method determination unit 205 can determine a method of appropriately displaying a plurality of pieces of defect information using the information read out from the metadata.

Display methods for improving convenience by using the information read out from the metadata even when only one piece of defect information is recorded in the inspection image file will be exemplified below.
(9) In accordance with the designated drawing level, the shape of the defect information is displayed in a simplified or detailed manner. A simplification method includes, for example, a Ramer-Douglas-Peucker algorithm as a method of simplifying vector data, and a method of replacing the shape by a simple symbol to specialize in indicating the position of the defect information. A detailing method includes, for example, a method of increasing vertices forming a polygon or a polyline and smoothing the shape. The drawing level may be determined dynamically in accordance with the resolution of the image. In this case, as information for further correcting the dynamically determined drawing level, a level at which the metadata is simplified or detailed may be used.
(10) The defect information is transparently displayed in accordance with the designated degree of transparency. By transparently displaying the defect information, it is possible to ensure visibility of the defect information and the actual defect included in the image.
(11) The defect information is displayed in the designated drawing form (the thickness and color of the line and the filling pattern of a surface). Similar to the degree of transparency, it is possible to highlight the defect information while ensuring visibility of the defect information and the actual defect included in the inspection image.

As described above, even when only one piece of defect information is recorded in the image file, a display method for improving convenience by using the information read out from the metadata can be determined. Note that the above-described display methods may be combined. Alternatively, even when there is no information in the metadata, a display method applied with an initial value can automatically be applied by presetting the initial value in the viewer.

### <S403: Display of Defect Information>

The display unit 207 superimposes and displays the defect information on the inspection image input in step S401 based on the metadata display method determined in step S402.

Next, processing of accepting a user operation of designating a metadata display method and recording information concerning the display method as metadata will be described with reference to FIG. 5.

In addition to the processing shown in FIGS. 3 and 4, the information concerning the display method designated by the user is recorded as metadata, thereby making it possible to display the inspection image and the defect information by the display method reflecting a user's intention at the time of reproducing the inspection image file.

### <S501: Superimposed Display of Defect Information>

The same processing as in steps S401 to S403 of FIG. 4 are performed.

### <S502: Designation of Display Method>

The user inputs the display method via the display method instruction unit 206. For example, the user sets display or non-display of the information stored in each layer of the defect information 601 shown in FIG. 6, and records the set information as a display flag in the metadata.

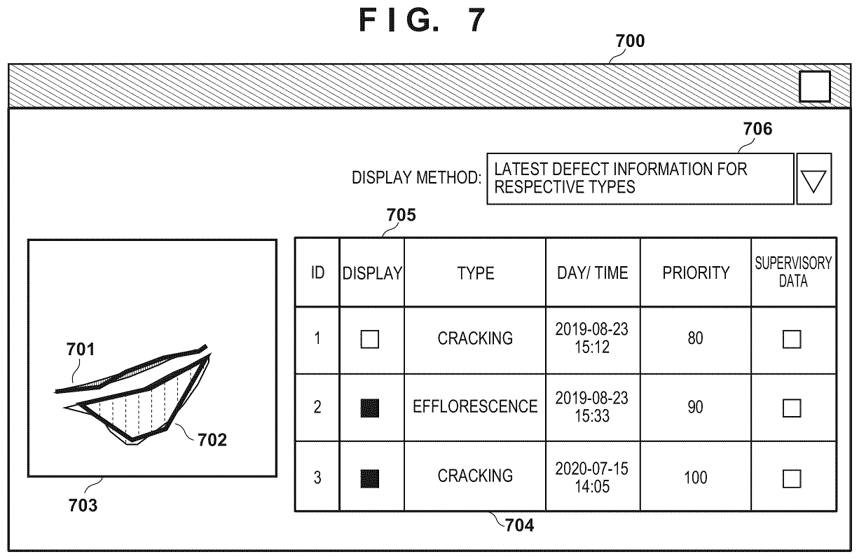

FIG. 7 exemplifies a reproduction screen 700 of the inspection image and the defect information according to the first embodiment.

Defect information 701 is defect information superimposed and displayed on actual cracking included in the inspection image. Defect information 702 is defect information superimposed and displayed on actual efflorescence included in the inspection image. An image display region 703 is a region where the defect information 701 and the defect information 702 are superimposed and displayed on the inspection image.

A defect information list 704 is a list of the pieces of defect information recorded in the inspection image file being displayed. The values in respective columns can be rearranged and some rows can be set in a non-display state. For example, by setting each checkbox displayed in a column 705 in a checked state or an unchecked state, display or non-display of the defect information superimposed and displayed in the image display region 703 can be switched.

In a list box 706, the initial setting of the display method is displayed as an option, and the user can select one of a plurality of options by pulling down the list box. The user may designate the display method by the list box 706 or individually set the display method by the checkbox of the column 705.

### <S503: Recording of Metadata>

The metadata recording unit 204 records, as metadata, information concerning the display method designated in step S502 in the inspection image file. For example, information concerning ON/OFF (TRUE/FALSE) of the display flag of the defect information is recorded as metadata. When the viewer displays the same inspection image file again, the defect information is displayed based on the display method recorded as the metadata. By recording the information concerning the display method as metadata in the inspection image file, as described above, it is easy to manage the information concerning the display method of the defect information.

According to the first embodiment, it is possible to determine the display method of the defect information based on the metadata recorded in the inspection image file, and appropriately superimpose and display the defect information on the inspection image at the time of reproducing the inspection image file. Furthermore, the user can designate the display method of the defect information recorded as the metadata, thereby making it possible to display the inspection image and the defect information by the display method reflecting the user's intention at the time of reproducing the inspection image file.

### Second Embodiment

The second embodiment will describe an example in which to confirm aging of a defect of a structure, past defect information is obtained from an image file different from an inspection image, and latest defect information and the past defect information are displayed to be compared with each other, and recorded as metadata.

The hardware configuration of an information processing apparatus 100 according to the second embodiment is the same as the configuration of the first embodiment shown in FIG. 1.

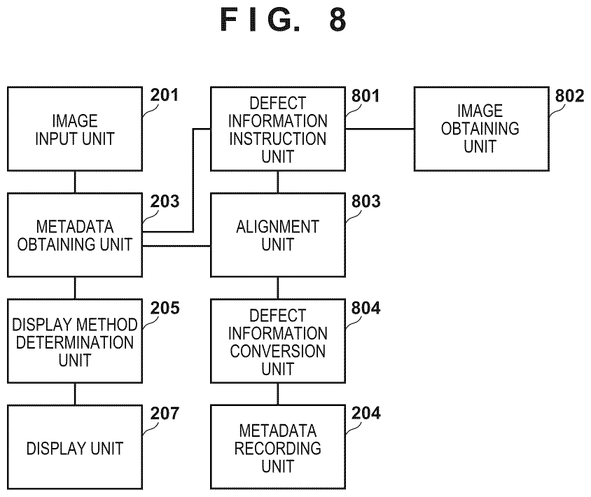

FIG. 8 is a functional block diagram of the information processing apparatus 100 according to the second embodiment. The same components as those shown in FIG. 2 according to the first embodiment are denoted by the same reference numerals.

The information processing apparatus 100 according to the second embodiment has a configuration in which a defect information instruction unit 801, an image obtaining unit 802, an alignment unit 803, and a defect information conversion unit 804 are added to the configuration shown in FIG. 2 according to the first embodiment and the display method instruction unit 206 is omitted.

Each function of the information processing apparatus 100 is configured by hardware and/or software. A configuration may be taken such that each functional unit is configured by one or more computer apparatuses or server apparatuses, and these constitute a system connected by a network. Further, when each functional unit illustrated in FIG. 8 is configured by hardware instead of being realized by software, there need only be provided a circuit configuration corresponding to each functional unit in FIG. 8.

The defect information instruction unit 801 accepts a user operation of designating second defect information that is different from first defect information obtained from an inspection image (first image file) and is recorded in a second image file.

The image obtaining unit 802 obtains the second image file storing the second defect information designated by the defect information instruction unit 801.

The alignment unit 803 accepts a user operation of aligning the first defect information obtained from the first image file and the second defect information obtained from the second image file.

The defect information conversion unit 804 converts coordinate information of the second defect information into the coordinate system of the first defect information based on the user operation of the alignment unit 803.

FIG. 9 is a flowchart illustrating control processing of the information processing apparatus 100 according to the second embodiment.

In step S901, an image input unit 201 inputs the first inspection image file (inspection image) designated by a user operation, similar to step S301 of FIG. 3.

In step S902, the image obtaining unit 802 externally inputs, via a storage device 104 and a network I/F 107, the second image file designated by a user operation. One or a plurality of second image files may be input. As a method of designating the second image file, the user may directly designate the second image file via a Graphical User Interface (GUI), or another method may be used. For example, a folder in which the file is stored may be designated, and all files stored in the folder may be set as targets or a file that satisfies a condition designated by the user may be set as a target using a search tool.

The defect information instruction unit 801 causes a metadata obtaining unit 203 to obtain the second defect information recorded as metadata in the second image file input in step S902, and presents a defect information list to the user. In this case, by performing processing of determining the difference between metadata of different data structures and appropriately converting the metadata, the pieces of defect information may be presented to the user so as to be conscious of the format difference.

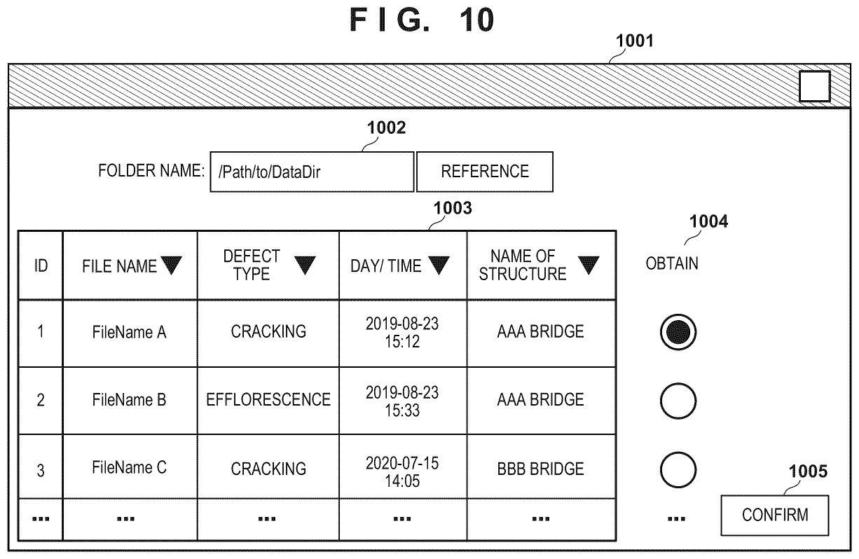

FIG. 10 exemplifies a list screen 1001 of the pieces of second defect information obtained in step S903 of FIG. 9.

When the user designates, in a folder input field 1002, a folder in which the second image file is stored, a list 1003 of the pieces of second defect information recorded as the metadata in the second image file stored in the designated folder is displayed. The pieces of second defect information are displayed in a table format. Pieces of information in respective columns can be rearranged and some rows can be set in a non-display state.

In step S903, the user designates, via the defect information instruction unit 801, the second defect information from the list screen 1001 of the pieces of defect information shown in FIG. 10. For example, the user designates, by a selection button 1004, the second defect information to be obtained, and determines it by a confirm button 1005. The second defect information is superimposed and displayed on the first image and the first defect information so that the user can perform comparison of the aging of the defect. Therefore, it is desirable to obtain the defect information of the same type from an image obtained by capturing the same portion of the same structure as in the first image. Therefore, the defect information list 1003 may narrow and display in advance the pieces of defect information detected from the image obtained by capturing the same portion of the same structure as in the first image or may rearrange these pieces of defect information to be displayed in an upper portion. Similarly, the defect information list 1003 may narrow and display the pieces of defect information of the same defect type as that of the first defect information of the first image or may rearrange these pieces of defect information to be displayed in an upper portion. As information of the structure and the defect type, metadata recorded in each image is used.

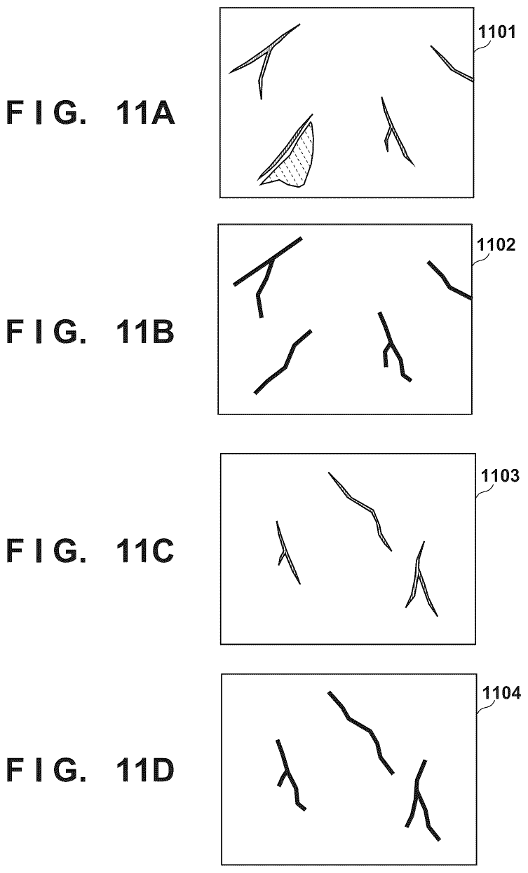

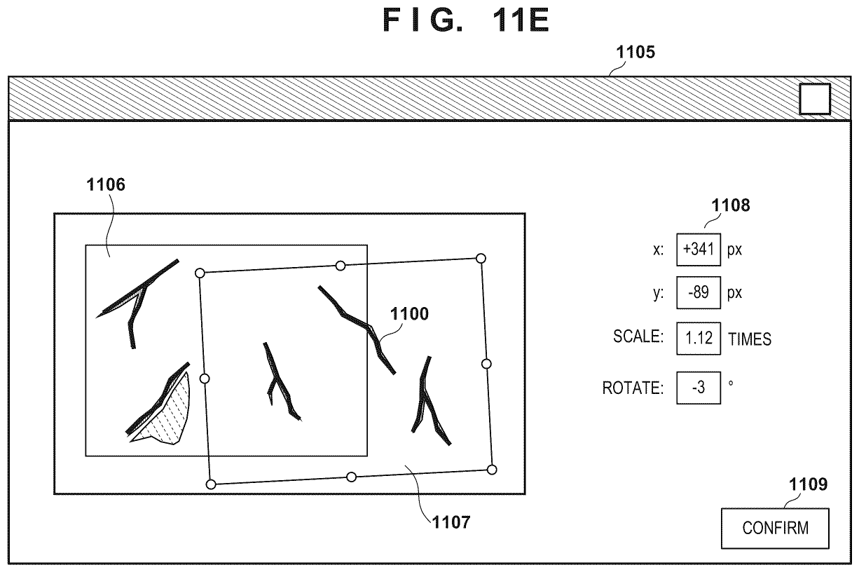

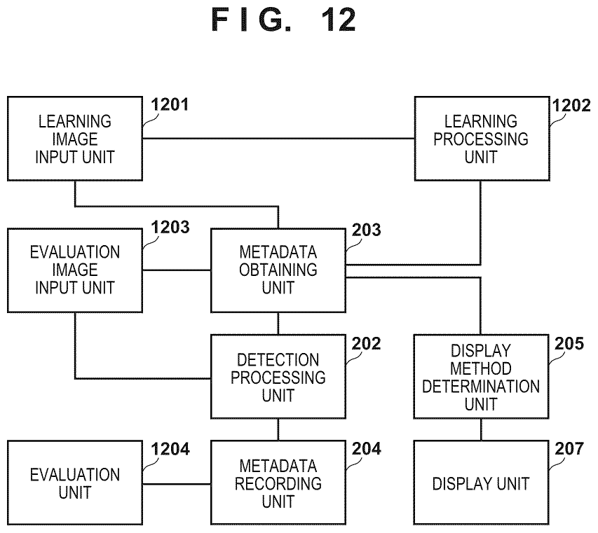

In step S904, a display unit 207 superimposes and displays, on the first image on which the first defect information is superimposed and displayed, the second image on which the second defect information is superimposed and displayed. In this case, the image obtaining unit 802 obtains the second defect information recorded as the metadata in the second image file. FIG. 11A shows a display example of a first image 1101. FIG. 11B exemplifies first defect information 1102 recorded as metadata in the first image file. FIG. 11C shows a display example of a second image 1103, and a display example of the image file in which the second defect information designated via the defect information instruction unit 801 by the user is recorded as the metadata. The second image file is an image file obtained by capturing the same structure as that in the first image before the first image 1101. FIG. 11D exemplifies second defect information 1104 recorded as metadata in the second image file, which is the second defect information designated via the defect information instruction unit 801 by the user. FIG. 11E exemplifies a screen 1105 for aligning, by the alignment unit 803, the first image on which the first defect information 1102 is superimposed and displayed and the second image on which the second defect information 1104 is superimposed and displayed. In the example shown in FIG. 11E, the first image 1101 and the first defect information 1102 are superimposed and displayed in a first image display region 1106, and the second image 1103 and the second defect information 1104 are superimposed and displayed in a second image display region 1107.

The second defect information 1104 is defect information recorded as metadata in the second image 1103 that is different from the first image 1101 and is captured before the first image 1101. When the same structure is captured at different times, it is difficult to completely match capturing ranges with each other, a deviation occurs between the capturing range of the first image and the capturing range of the second image, and the first defect information and the second defect information also deviate from each other.

In step S905, the alignment unit 803 accepts a user operation of aligning the first image 1101 and the first defect information 1102 in the first image display region 1106 and the second image 1103 and the second defect information 1104 in the second image display region 1107. On the screen 1105 shown in FIG. 11E, the user can designate positions, scales, angles, and the like so that the first image 1101 and the first defect information 1102 in the first image display region 1106 overlap the second image 1103 and the second defect information 1104 in the second image display region 1107. The user performs alignment by dragging the second image 1103 in the second image display region 1107 and inputting a value in each information input field 1108 on the screen 1105 shown in FIG. 11E.

The screen 1105 shown in FIG. 11E exemplifies a state in which the alignment of the first image 1101 and the first defect information 1102 in the first image display region 1106 and the second image 1103 and the second defect information 1104 in the second image display region 1107 is complete. After the completion of the alignment, the user operates a confirm button 1109 to confirm the positional relationship among the first image 1101 and the first defect information 1102 in the first image display region 1106 and the second image 1103 and the second defect information 1104 in the second image display region 1107. Then, the first defect information obtained by correcting the position, the scale, the angle, and the like is recorded as metadata in the first image file.

In the example shown in FIG. 11E, for the sake of descriptive simplicity, a state in which the first image 1101 and the second image 1103 are superimposed and displayed and the first defect information 1102 and the second defect information 1104 are superimposed and displayed is exemplified but all the images and the pieces of defect information need not always be superimposed and displayed at the same time. By statically or dynamically adjusting the drawing form such as the degree of transparency and the thickness and color of the line, it becomes easier to perform an alignment operation. To further facilitate the alignment operation, feature extraction processing of the image and the defect information may be performed and auxiliary processing of performing alignment so that an error is minimized may automatically be performed.

In step S906, the defect information conversion unit 804 converts the shape of the second defect information in accordance with information concerning the alignment performed via the alignment unit 803 by the user. The shape of the second defect information may be simplified or detailed in accordance with the resolution of the first image. In this case, the shape of the second defect information may be actually simplified or detailed by geometric calculation or information of a drawing level calculated in advance may be included in the defect information so as to dynamically simplify or detail the shape of the defect information at the time of superimposed display.

The defect information conversion unit 804 divides the second defect information at the boundary of the range of the first image to distinguish between the second defect information falling within the range of the first image and the second defect information falling outside the range of the first image. For example, second defect information 1100 shown in FIG. 11E protrudes from the first image display region 1106, and is divided by the first image display region 1106. The divided defect information outside the first image display region 1106 is added with information representing the state and stored in a layer different from that of the defect information in the first image display region 1106. Note that the defect information outside the first image display region 1106 may be stored in the same layer or may be deleted without being stored.

In the second embodiment, to allow confirmation of aging of a defect of a structure, for a portion falling within the range of the first image and outside the range of the second image after alignment, it is necessary to record information representing the state. This is because when comparing pieces of defect information of different capturing times, it is impossible to distinguish whether such portion is a portion where there was no defect in the past or a portion falling outside the capturing range of the past defect information.

To cope with this, in the second embodiment, the shape of the second image display region 1107 is also recorded as metadata together with the second defect information inside the first image display region 1106. The shape of the second image display region can readily be distinguished from the shape of the defect, and thus there is no problem with recording the shape of the second image display region as part of the defect information. Note that the shape information of the second image display region may be stored in a layer different from that of the defect information or the same layer.

In step S907, a metadata recording unit 204 records, as metadata, the second defect information converted in step S906 in the first image file. In this case, the related information of the second image may be recorded. The related information of the second image includes, for example, the size, the capturing position, the capturing date/time of the second image, a file name, a file path, the ID of the image file, the resolution of the image, the hash value of the image file, and the main body data (binary data or data encoded in a character string) of the image.

To reduce a data amount, the second defect information may be recorded as a difference from the first defect information. In this case, the ID of the base defect information is also recorded in the layer of the defect information of the difference.

In the above-described processing of FIG. 9, information necessary to confirm aging of a defect of a structure can be stored in one image file.

Processing of displaying defect information so as to confirm aging of a defect based on an image file in which the defect information is recorded as metadata will be described next.

When the first image file is input to a viewer, the display method determination unit 205 causes the metadata obtaining unit 203 to obtain the first defect information and the second defect information from the first image file. Then, the capturing date/time of the first defect information is compared with the capturing date/time of the second defect information, and the latest defect information and the oldest defect information are extracted. The display unit 207 superimposes and displays the defect information as an extraction result on the first image. This allows the user to readily confirm aging of a defect within the capturing range of the structure only by performing a reproduction operation of the first image file. Note that for the main purpose of confirming the latest defect which the user may be highly interested in, only the latest defect information may be superimposed and displayed.

After displaying the first image, the user can designate a display method in accordance with a user's intention. Since the second embodiment aims at confirming aging of a defect, the user designates times to be compared, the display method determination unit 205 extracts the defect information matching each of the designated times, and the display unit 207 superimposes and displays the defect information. Furthermore, the metadata recording unit 204 records, as metadata, the times designated by the user. Note that with reference to the date/time and the like of the defect information list 704 shown in FIG. 7 according to the first embodiment, the user may designate the defect information to be displayed, and record it as a display flag in the metadata. By recording, as metadata, the display method designated by the user in the image file, another user who reproduces the same image file can view and confirm aging of the defect by the same display method.

According to the second embodiment, by loading, into the first image file, the second defect information recorded as metadata in the second image file obtained by capturing the same structure as that in the first image file before the first image file, it is possible to appropriately superimpose and display the pieces of defect information of different capturing times by one image file, and the user can confirm aging of a defect of the structure.

### Third Embodiment

The third embodiment will describe an example in which a defect detection result is evaluated by learning processing and inference processing with respect to defect information recorded as metadata in an image file.

The hardware configuration of an information processing apparatus 100 according to the third embodiment complies with the configuration of the first embodiment shown in FIG. 1 and a description thereof will be omitted.

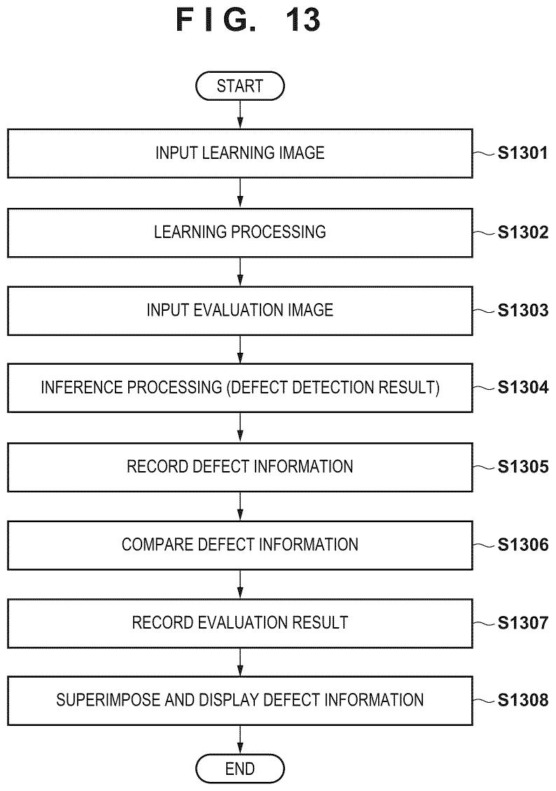

FIG. 12 is a functional block diagram of the information processing apparatus 100 according to the third embodiment.

The information processing apparatus 100 according to the third embodiment has a configuration in which a learning image input unit 1201, a learning processing unit 1202, an evaluation image input unit 1203, an evaluation unit 1204 are added to the configuration shown in FIG. 2 according to the first embodiment and the image input unit 201 and the display method instruction unit 206 are omitted.

Each function of the information processing apparatus 100 is configured by hardware and/or software. A configuration may be taken such that each functional unit is configured by one or more computer apparatuses or server apparatuses, and these constitute a system connected by a network. Further, when each functional unit illustrated in FIG. 12 is configured by hardware instead of being realized by software, there need only be provided a circuit configuration corresponding to each functional unit in FIG. 12.

The learning image input unit 1201 externally inputs, via a storage device 104 and a network I/F 107, a learning image file designated by a user operation.

The learning processing unit 1202 executes machine learning using the learning image input by the learning image input unit 1201, and generates a learned model.

The evaluation image input unit 1203 externally inputs, via the storage device 104 and the network I/F 107, an evaluation image file designated by a user operation.

The evaluation unit 1204 executes, by using the learned model, inference processing for the evaluation image input by the evaluation image input unit 1203, and evaluates a defect detection processing result based on an inference result.

FIG. 13 is a flowchart illustrating control processing of the information processing apparatus 100 according to the third embodiment.

In step S1301, the learning image input unit 1201 inputs a learning image file designated by a user operation, and a metadata obtaining unit 203 obtains defect information recorded as metadata in the learning image file. When loading the metadata of the learning image file, the metadata obtaining unit 203 loads defect information whose supervisory data flag is TRUE as a loading target. Note that candidates of pieces of defect information to be loaded may further be narrowed by another metadata. For example, a defect type may be limited or a structure may be limited. A screen for displaying a list of pieces of defect information as candidates may be displayed, and the user may be able to instruct an additional condition while confirming the list screen.

Note that when there exist a plurality of candidates to be loaded with respect to the same image, reliability may be determined based on another metadata and defect information with higher reliability may be set as a loading target. For example, defect information input by an experienced inspector is prioritized, defect information obtained by correcting, by a human, defect information generated by machine learning is prioritized, defect information with a high display priority is prioritized, or defect information with the latest capturing date/time is prioritized.

In step S1302, the learning processing unit 1202 executes machine learning using the learning image input in step S1301, and generates a learned model. The machine learning may be performed by any method.

In step S1303, the evaluation image input unit 1203 inputs an evaluation image file designated by a user operation, and the metadata obtaining unit 203 obtains defect information recorded as metadata in the evaluation image file. When loading the metadata of the evaluation image file, the metadata obtaining unit 203 loads defect information whose supervisory data flag is TRUE. Note that for example, if a folder in which the learning image file is stored is distinguished from a folder in which the evaluation image file is stored, the supervisory data flag may be referred to instead of the evaluation data flag. Similar to the learning image file, candidates of pieces of defect information to be loaded may further be narrowed by another metadata.

In step S1304, a detection processing unit 202 performs inference processing (defect detection processing) for the evaluation image loaded in step S1303 using the learned model generated in step S1302.

In step S1305, a metadata recording unit 204 records, as metadata, the defect information detected by the inference processing in step S1304 in the evaluation image file. In this case, the parameter and the ID of the learned model used for the inference processing may be recorded.

In step S1306, the evaluation unit 1204 compares the defect information loaded from the evaluation image file in step S1303 with the defect information detected and recorded in steps S1304 and S1305, and evaluates a defect detection result. The evaluation method may be any method, and a method of calculating a numerical value as a quantitative evaluation result, for example, the Recall, Precision, f-number, or the like is used.

In step S1307, the metadata recording unit 204 records, as metadata, the evaluation value calculated in step S1306 in the evaluation image file. In this case, the evaluation value is recorded in association with the defect information detected and recorded in steps S1304 and S1305. For example, the evaluation value may be stored as metadata in the same layer as that of the detection result in step S1304, or the ID of the defect information of the detection result may be recorded together with the evaluation value.

In step S1308, a display method determination unit 205 determines a display method of the defect information loaded from the evaluation image file in step S1303 and the defect information detected and recorded in steps S1304 and S1305. Based on the display method determined by the display method determination unit 205, the display unit 207 superimposes and displays, on the evaluation image, the defect information loaded from the evaluation image file in step S1303 and the defect information detected and recorded in steps S1304 and S1305.

Note that the processing in steps S1301 to S1307 are executed by a high-performance first information processing apparatus and step S1308 is executed by a second information processing apparatus different from the first information processing apparatus, but all the processing may be executed by the same computer.

The display method determination unit 205 causes the metadata obtaining unit 203 to obtain, from the evaluation image, the defect information and the evaluation value of the latest detection result and the defect information used for evaluation, and appropriately superimposes and displays these pieces of information on the evaluation image. For example, the defect information of the detection result and the defect information used for evaluation are drawn by colors or line widths so as to be readily distinguished. In this case, since the user is interested in the detection result, the defect information of the detection result is drawn on the defect information used for evaluation, thereby preventing the detection result from being hidden.

Note that a plurality of detection results recorded in the evaluation image may be displayed in addition to the latest detection result. In this case, information of the learned model and the parameter is displayed at the same time, thereby making it easy to confirm the difference in detection result caused by a difference in parameter.

According to the third embodiment, by adding the evaluation value and the defect information detected by the inference processing using the learned model with respect to the defect information recorded as metadata in the evaluation image file, it is possible to appropriately superimpose and display the defect information of the evaluation image file, the defect information detected using the learned model, and the evaluation result.

### Modification

Each of the above-described first to third embodiments has explained an example in which defect information detected from an inspection image obtained by capturing a structure as an inspection target is recorded as metadata in an image file and can be superimposed and displayed on the inspection image but the present invention is not limited to this.

For example, the present embodiment may be applied to an inspection image including a lesion captured by a medical apparatus such as a CT or MRI and lesion information (inspection information) recorded as metadata in an inspection image file.

In this case as well, similar to the first to third embodiments, the lesion information detected from the inspection image is recorded as metadata in the inspection image file, and the lesion information is superimposed and displayed on the inspection image by an automatically determined display method or a display method designated by the user at the time of reproducing the inspection image file.

For example, a doctor sets a display flag so as to display only a malignant lesion among lesions included in an inspection image, and adds a diagnostic comment to the lesion. An inspection image file records a plurality of pieces of lesion information as metadata but these pieces of information are not uniformly superimposed and displayed and the metadata is recorded to be displayed by a display method intended by the doctor.

Furthermore, the inspection image file recording the metadata is not limited to a still image and may be a content data file including a sound and/or a moving image, and the metadata may be information derived from content data. For example, when the inspection image file is a moving image file including a plurality of scenes and metadata for explaining each scene is stored, a subject flag indicating a subject is given to the scene as the subject of the entire moving image among the plurality of scenes, thereby making it possible to display only the subject scene by the viewer, superimpose and display subject information during display, or highlight a moving image region only during display of the subject scene. In addition, information for instructing the display order of the scenes may be recorded as metadata and the scenes may be displayed in this order.

When information obtained by converting the speech of each attendee into text is recorded as metadata for each speaker in a sound file obtained by recording a meeting as content data, a priority can be set for each attendee to preferentially reproduce the speech of the attendee with a high priority or display subtitles.

Even when a plurality of content data files are combined into one container file, for example, information added, as a representative of a plurality of titles, to the container file is recorded as metadata with respect to information recorded as metadata in each content data file, thereby making it possible to improve convenience.

As described above, by recording various kinds of information as metadata in a content data file and also recording, as metadata, information concerning a method for handling these pieces of information, it is possible to handle the content data file and the information recorded as the metadata by a method reflecting a user's intention.

According to the present embodiment, it is possible to handle supplementary information recorded in content data while suppressing degradation in convenience.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An information processing apparatus comprising:
a first obtaining unit that obtains first detection information attached to a first image as metadata;
a determination unit that determines a display method of the first detection information obtained by the first obtaining unit; and
a display unit that superimposes and displays the first detection information on the first image based on the display method determined by the determination unit.

2. The information processing apparatus according to claim 1, further comprising a recording unit that records, in the first image, as supplementary information, the first detection information detected from the first image.

3. The information processing apparatus according to claim 2, further comprising a detection processing unit that executes detection processing for the first image and generates the first detection information as a detection result,
wherein the recording unit records, in the first image, as supplementary information, the first detection information detected by the detection processing unit.

4. The information processing apparatus according to claim 3, further comprising a first instruction unit that accepts a user operation of designating the display method,
wherein the recording unit records, in the first image, as supplementary information, the display method designated by the user operation.

5. The information processing apparatus according to claim 2, wherein
the supplementary information includes a priority of the first detection information,
the determination unit determines the display method based on the priority of the first detection information, and
the display unit displays the first detection information in accordance with the priority.

6. The information processing apparatus according to claim 5, wherein the display unit displays the first detection information whose priority is highest or not lower than a threshold.

7. The information processing apparatus according to claim 5, wherein
the supplementary information includes information representing that the first detection information is set as a display target, and
the display unit displays the first detection information set as the display target.

8. The information processing apparatus according to claim 2, wherein
the supplementary information includes a type of the first detection information and a generation date/time of the first detection information, and
the display unit displays the first detection information with the latest generation date/time for each type of the first detection information.

9. The information processing apparatus according to claim 2, wherein
the first image is a captured image,
the information processing apparatus further comprises a second obtaining unit that obtains second detection information recorded as supplementary information in a second image whose capturing time is different from that of the first image, and
the display unit superimposes and displays the second detection information on the first image.

10. The information processing apparatus according to claim 9, further comprising:
a second instruction unit that accepts a user operation of designating the second image; and
a third instruction unit that accepts a user operation of designating the second detection information.

11. The information processing apparatus according to claim 9, further comprising an operation unit that accepts a user operation of aligning a position of the first detection information superimposed and displayed on the first image and a position of the second detection information superimposed and displayed on the second image.

12. The information processing apparatus according to claim 11, wherein the recording unit records, as supplementary information, a portion that falls within a range of the first image and falls outside a range of the second image after the alignment.

13. The information processing apparatus according to claim 10, wherein
the second detection information is divided into third detection information within a range of the first image and fourth detection information outside the range of the first image,
the recording unit records the third detection information as supplementary information of the first image, and
the display unit superimposes and displays the first detection information and the third detection information on the first image.

14. The information processing apparatus according to claim 13, wherein the recording unit records a shape of the second image as supplementary information of the first image.

15. The information processing apparatus according to claim 13, wherein the recording unit records the fourth detection information as related information of the first detection information.

16. The information processing apparatus according to claim 2, further comprising:
a first input unit that inputs a learning image;
a learning processing unit that generates a learned model from the learning image;
a second input unit that inputs an evaluation image;
a detection processing unit that performs inference processing for the evaluation image using the learned model and obtains first detection information;
an obtaining unit that obtains second detection information recorded as supplementary information in the evaluation image; and
an evaluation unit that compares the first detection information and the second detection information.

17. The information processing apparatus according to claim 16, wherein the recording unit records the first detection information as supplementary information in the evaluation image.

18. The information processing apparatus according to claim 16, wherein the recording unit records an evaluation result of the evaluation unit as supplementary information in the evaluation image.

19. The information processing apparatus according to claim 16, wherein the display unit superimposes and displays the first detection information and the second detection information on the evaluation image.

20. The information processing apparatus according to claim 16, wherein
the supplementary information includes one of information representing whether the learning image is usable as supervisory data and information representing whether the evaluation image is usable as evaluation data,
the first input unit inputs the learning image usable as the supervisory data, and
the second input unit inputs the evaluation image usable as the evaluation data.

21. The information processing apparatus according to claim 1, wherein the detection information is defect information detected from an image obtained by capturing a structure.

22. The information processing apparatus according to claim 1, wherein the detection information is lesion information detected from an inspection image captured by a medical apparatus.

23. An information processing apparatus comprising:
an obtaining unit that obtains predetermined supplementary information recorded in a content data file; and
a control unit that performs processing of the content data file and the predetermined supplementary information based on information included in the predetermined supplementary information and concerning a method for handling the predetermined supplementary information.

24. An information processing method comprising:
obtaining detection information attached to an image as metadata;
determining a display method of the obtained detection information; and
superimposing and displaying the detection information on the image based on the determined display method.

25. An information processing method comprising:
obtaining predetermined supplementary information recorded in a content data file; and
performing processing of the content data file and the predetermined supplementary information based on information included in the predetermined supplementary information and concerning a method for handling the predetermined supplementary information.

26. A non-transitory computer-readable storage medium storing a program for causing a computer to function as an information processing apparatus comprising:
a first obtaining unit that obtains first detection information attached to a first image as metadata;
a determination unit that determines a display method of the first detection information obtained by the first obtaining unit; and
a display unit that superimposes and displays the first detection information on the first image based on the display method determined by the determination unit.

27. A non-transitory computer-readable storage medium storing a program for causing a computer to function as an information processing apparatus comprising:
an obtaining unit that obtains predetermined supplementary information recorded in a content data file; and
a control unit that performs processing of the content data file and the predetermined supplementary information based on information included in the predetermined supplementary information and concerning a method for handling the predetermined supplementary information.
